(19) United States
(12) Patent Application Publication
(10) Pub. No.: US 2019/0270285 A1
(43) Pub. Date: Sep. 5, 2019

(54) COMPOSITE PANE AND METHOD FOR MANUFACTURING A COMPOSITE PANE

(71) Applicant: SAINT-GOBAIN GLASS FRANCE, Courbevoie (FR)

(72) Inventors: Stephan GILLESSEN, Alsdorf (DE); Pascal BAUERLE, Roye (FR); Jean Jacques BRIS, Bey (FR)

(21) Appl. No.: 16/345,441

(22) PCT Filed: Sep. 21, 2017
(86) PCT No.: PCT/EP2017/073921

§ 371 Date: Apr. 26, 2019

(30) Foreign Application Priority Data
Oct. 28, 2016 (EP) 16196248.5

(51) Int. Cl. B32B 17/10; B32B 37/18; B32B 38/00

(52) U.S. Cl. CPC B32B 17/10541; B32B 17/10036; B32B 2605/00; B32B 38/0012; B32B 37/182

(57) ABSTRACT

A composite pane for a motor vehicle has a first pane and a second pane, wherein the two panes are laminated with an interposed plastic film. At least one depression is introduced into the plastic film in the direction of the first pane, in which depression a light-emitting diode is arranged, wherein a light-emission side of the light-emitting diode is oriented in the direction of the first pane.

The invention relates to a composite pane for a motor vehicle. The invention further relates to a method for manufacturing a composite pane for a motor vehicle. The invention relates, moreover, to use of a composite pane according to the invention as a windshield of a motor vehicle.

Conventionally, electronic components are arranged between respective panes of a composite glass pane in order to fulfill various tasks depending on the purpose of the application. CH 698260 B1 discloses, for example, a built-in element with a flexible polymer film, such as PET, translucently coated using conductive oxide or metal, as well as electronic components bonded via electrically conducting adhesive spots, wherein the electrically conducting adhesive spots between the conductive coating and the components are protected against compressive, tensile, or shear forces by electrically nonconducting reinforcing adhesive spots.

EP 2100722 A2 discloses a light sensor that is laminated in a windshield. The windshield with the integrated light sensor can be provided in a compact manner, eliminating a subsequent installation of the light sensor. The light sensor is implemented in the form of flip-chip photo diodes on a circuit board.

A disadvantage of the aforementioned solutions consists in that the respective electronic components are arranged adjacent the thermoplastic intermediate layer such that they rest on the intermediate layer and the intermediate layer thus compensates a thickness of the respective electronic components. Consequently, it is necessary to use electronic components that are as thin as possible in order to ensure that the intermediate layer can compensate the thickness of the electronic components. With the use of thicker electronic components, glass breakage can, consequently, disadvantageously occur when the intermediate layer is incapable of compensating the thickness of the electronic components and, thus, stresses develop in the panes.

The international patent application WO2016079459A1 discloses a composite pane, wherein diodes are arranged in openings of a thermoplastic intermediate layer.

The object of the invention is thus to provide an improved composite pane as well as an improved method for manufacturing the composite pane that enables the use of thicker electronic components without producing stresses in the composite pane. In addition, the composite pane should be reliably producible with high optical quality.

These and other objects of the present invention are accomplished according to the invention by a composite pane for a motor vehicle, a method for manufacturing a composite pane for a motor vehicle, and by use of the composite pane according to the invention as a windshield of a motor vehicle according to the coordinate claims.

The present invention presents a composite pane for a motor vehicle, having a first pane and a second pane, wherein the two panes are laminated by a plastic film arranged therebetween, and wherein at least one depression is introduced into the plastic film, in which depression a light-emitting diode is arranged. The depression is recessed in the direction of the first pane and a light-emission side of the light-emitting diode is oriented in the direction of the first pane.

According to the invention, through provision of the at least one depression that is introduced in the plastic film, the light-emitting diode can be arranged between the first pane and the second pane of the composite pane such that the light-emitting diode generates no stresses of the composite pane. In particular, local bulging of the plastic film in the region of the light-emitting diode can be avoided. Advantageously, relatively thick light-emitting diodes can be used, which are, in contrast to very thin light-emitting diodes, significantly more economical to produce.

In addition, the invention enables, in a particularly advantageous manner, production of composite panes of optically high quality with very good light transmittance of the light of the at least one light-emitting diode through the first pane. The provision of depressions instead of perforations or openings in the plastic film ensures that the material of the plastic film is always situated between the light-emitting diode and the first pane such that the generation of usually clearly visible bubbles in the intermediate region between the light-emitting diode and the first pane can be effectively prevented. Since the optical refractive index of the plastic film is typically matched to the optical refractive index of the first pane, no undesirable jump in the refractive index occurs. With the formation of gas-filled or evacuated bubbles, this is not the case. Due to the difference in the optical refractive index of the first pane and bubbles, the bubbles are readily visible and the optical quality of the composite pane is adversely affected. In addition, it can always be ensured that a homogeneous layer of the material of the plastic film is present between the light-emitting diode and the first pane, since backflow into the space between the light-emitting diode and the first pane is not required. A composite pane with high optical quality can be reliably and safely produced.

The present invention further presents a method for manufacturing a composite pane for a motor vehicle. The method includes providing a first pane and a second pane as well as providing a plastic film. The method moreover includes introduction of at least one depression into plastic film, wherein the depression is introduced such that, in the laminated state of the first pane and the second pane, it is recessed in the direction of the first pane, as well as arranging a light-emitting diode in the at least one depression of the plastic film, and laminating the first pane, the second pane, and the plastic film arranged therebetween.

The present invention further presents the use of the composite pane according to the invention as a windshield of a motor vehicle.

Provision is made according to one embodiment for the light-emitting diode to be arranged on a circuit board comprising, for example, a plastic film. Thus, the power supply of the light-emitting diode can be ensured and a desired positioning can be enabled depending on the structural requirements in the region of the composite pane.

According to another embodiment a plurality of light-emitting diodes, electrically conductingly connected to one another, for example, by an electrically conducting wire, are provided. Providing the electrically conducting wire for connecting the light-emitting diodes advantageously enables a flexible arrangement of the light-emitting diodes with low material costs.

Provision is made according to another embodiment for introducing the at least one depression of the plastic film into the plastic film by milling using a milling tool or by hot stamping using a hot stamping punch. Thus, the at least one depression of the plastic film can be produced or introduced by various methods depending on requirements.

Provision is made according to another embodiment for the light-emitting diode to have a thickness of as much as 1 mm, preferably of as much as 0.7 mm. Light-emitting diodes of this thickness are significantly more economical than thinner light-emitting diodes and thus contribute to a cost reduction of the composite pane.

Provision is made according to another embodiment for the at least one depression of the plastic film to have a diameter of at least 2 mm, preferably of at least 3 mm, with the depression being produced with a depth of as much as 90% of a thickness of the plastic film.

The at least one depression of the plastic film can thus be produced flexibly according to the respective requirements regarding both diameter and depth and is thus adaptable to any dimensions of light-emitting diodes.

Provision is made according to another embodiment for the plastic film to include polyvinyl butyral, ethylene vinylacetate, polyacrylate, polymethyl methacrylate, or polyurethane or to be made of one or a plurality of these materials. Thus, depending on requirements, a suitable material of the plastic film can be selected for a corresponding purpose of application.

Provision is made according to another embodiment for a light-emission side of the light-emitting diode to be oriented toward the first pane. The first pane can be the inner pane or the outer pane of the composite pane such that the light-emitting diode can, for example, be oriented toward a passenger compartment or toward an exterior of the motor vehicle. This yields a different purpose of application depending on the orientation of the light-emitting diode.

Provision is made according to another embodiment for introducing the at least one depression of the plastic film into the plastic film by milling using a milling tool, with the at least one depression of the plastic film having a diameter of at least 2 mm, preferably of at least 3 mm.

Provision is made according to another embodiment for producing the at least one depression with a depth of as much as 90% of a thickness of the plastic film. Thus, a large part of the thickness of the plastic film can be used for the arrangement of the light-emitting diode. On the other hand, sufficient material remains between the light-emitting diode and the first pane to ensure the high optical quality of the composite pane.

Provision is made according to another embodiment for introducing the at least one depression of the plastic film into the plastic film by hot stamping using a hot stamping punch, with the at least one depression of the plastic film having a diameter of at least 2 mm, preferably of at least 3 mm. Introducing the depression of the plastic film by hot stamping can make sense depending on the selection of the material of the plastic film and can be carried out very quickly depending on the design of the hot stamping punch.

Provision is made according to another embodiment for carrying out the hot stamping of the at least one depression of the plastic film with a stamping temperature of the hot stamping punch of 50 to 150° C., preferably of 80 to 150° C., with a shape of the at least one depression of the plastic film such that the shape of the at least one depression of the plastic film corresponds to the design of the light-emitting diode. Thus, the at least one depression of the plastic film can be adapted to the design of the light-emitting diode.

The embodiments and developments described can be combined with one another as desired. Other possible embodiments, developments, and implementations of the invention also include combinations not explicitly mentioned of features of the invention described previously or in the following with reference to the exemplary embodiments.

### BRIEF DESCRIPTION OF THE DRAWINGS

They depict:

FIG. 1 a schematic representation of a prior art composite pane for a motor vehicle;

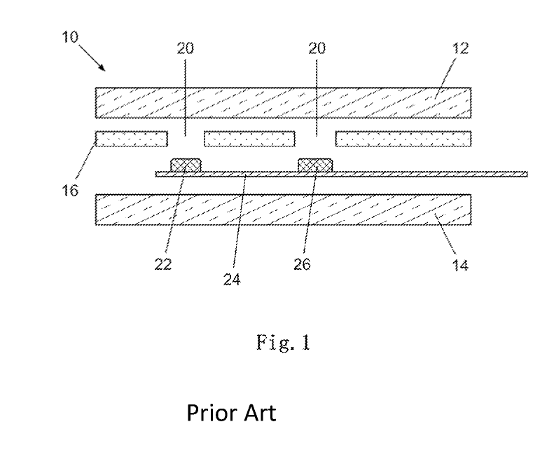

FIG. 2 a schematic representation of the composite pane for the motor vehicle according to one embodiment of the invention; and

FIG. 3 a flowchart of a method for manufacturing the composite pane for the motor vehicle.

In the figures of the drawings, like reference characters refer to the same or functionally equivalent elements or components, unless otherwise indicated.

The composite pane 10 for a motor vehicle has a first pane 12 and a second pane 14. The first pane 12 and the second pane 14 are laminated with a plastic film 16. Two openings 20 are introduced into the plastic film 16. A light-emitting diode 22, 26 is inserted into each of the openings 20. The present schematic representation is an exploded view of the composite pane for the motor vehicle, in order to enable easier visualization of the installed components.

The light-emitting diodes 22, 26 are arranged on a circuit board 24. During lamination of the two panes 12, 14, soft material of the plastic film 16 flows into the space between the light-emitting diodes 22, 26 and the first pane 12. Due to a relatively high viscosity of the material, it is impossible to reliably ensure that a homogeneous material layer is situated between the light-emitting diodes 22, 26 and the first pane 12. Especially in the case of inadequate backflow, there is the risk of the formation of bubbles which, also because they are illuminated by the light-emitting diodes 22, 26, are visible from the outside and adversely affect the optical quality of the composite pane 10 significantly.

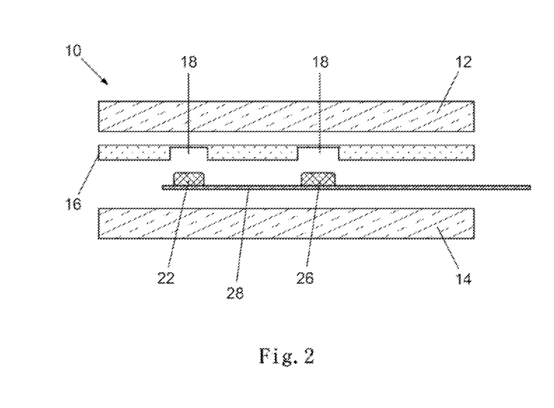

FIG. 2 depicts a schematic representation of the composite pane for the motor vehicle according to one embodiment of the invention.

The composite pane 10 for the motor vehicle has, according to the present embodiment, a first pane 12 and a second pane 14. Situated between the first pane 12 and the second pane 14 is a plastic film 16, by means of which the two panes 12, 14 are laminated. According to the present embodiment, two depressions 18, into which respective light-emitting diodes 22, 26 are inserted, are introduced into the plastic film.

According to the present embodiment, the light-emitting diodes 22, 26 are connected to one another by an electrically conducting wire 28. Alternatively, the light-emitting diodes 22, 26 can, for example, be arranged on a circuit board comprising a film. The depressions 18 of the plastic film 16 are, for example, introduced into the plastic film 16 by milling using a milling tool. Alternatively, the depressions 18 can, for example, be introduced into the plastic film 16 by hot stamping using a hot stamping punch.

The light-emitting diodes 22, 26 preferably have a thickness of as much as 0.7 mm. Alternatively, the thickness can, for example, be as much as 1 mm. The depressions 18 of the plastic film 16 preferably have a diameter of at least 2 mm, preferably of at least 3 mm. The depressions 18 are produced with a depth of as much as 90% of a thickness of the plastic film 16. The plastic film 16 is made of polyvinyl butyral in the present embodiment. Alternatively, the plastic film 16 can be made, for example, of ethylene vinylacetate, polyacrylate, polymethyl methacrylate, or polyurethane. In the present embodiment, a light-emission side of the light-emitting diodes 22, 26 is oriented toward the first pane 12.

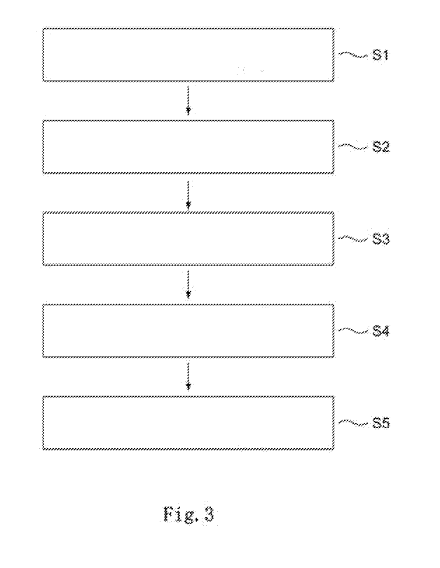

FIG. 3 depicts a flowchart of a method for manufacturing the composite pane for the motor vehicle according to the invention.

The method includes, according to step S1, providing a first pane and a second pane. The method also includes, according to step S2, providing a plastic film. The method further includes, according to step S3, introducing at least one depression into the plastic film. The method includes, moreover, according to step S4, arranging a light-emitting diode in the at least one depression of the plastic film. The method includes, additionally, according to step S5, laminating the first pane and the second pane with the interposed plastic film.

The at least one depression of the plastic film is introduced into the plastic film, for example, by milling using a milling tool, wherein the at least one depression has a diameter of at least 2 mm, preferably of at least 3 mm. The depression is, for example, produced with a depth of as much as 90% of a thickness of the plastic film 16.

Alternatively, the at least one depression of the plastic film can be introduced into the plastic film by hot stamping using a hot stamping punch, wherein the at least one depression of the plastic film has a diameter of at least 2 mm, preferably of at least 3 mm.

The hot stamping of the at least one depression of the plastic film 16 is preferably carried out with a stamping temperature of the hot stamping punch from 50 to 150° C., preferably from 80 to 150° C. The shape of the at least one depression of the plastic film can be designed such that the shape of the at least one depression of the plastic film corresponds to a design of the light-emitting diode.

### LIST OF REFERENCE CHARACTERS

10 composite pane
12 first pane
14 second pane
16 plastic film
18 depression
20 opening
22 light-emitting diode
24 circuit board
26 other light-emitting diode
28 electrically conducting wire

1. A composite pane for a motor vehicle, comprising a first pane and a second pane, wherein the first pane and the second pane are laminated with a plastic film arranged therebetween, wherein at least one depression is introduced into the plastic film in a direction of the first pane, in which at least one depression a light-emitting diode is arranged, wherein a light-emission side of the light-emitting diode is oriented in the direction of the first pane.

2. The composite pane according to claim 1, wherein the light-emitting diode is arranged on a circuit board.

3. The composite pane according to claim 1, wherein a plurality of light-emitting diodes that are electrically connected to one another by an electrically conducting wire are provided.

4. The composite pane according to claim 1, wherein the at least one depression of the plastic film is introduced into the plastic film by milling using a milling tool or by hot stamping using a hot stamping punch.

5. The composite pane according to claim 1, wherein the light-emitting diode has a thickness of as much as 1 mm.

6. The composite pane according to claim 1, wherein the at least one depression of the plastic film has a diameter of at least 2 mm and wherein the at least one depression has a depth of as much as 90% of a thickness of the plastic film.

7. The composite pane according to claim 1, wherein the plastic film contains polyvinyl butyral, ethylene vinylacetate, polyacrylate, polymethyl methacrylate, or polyurethane.

8. A method for manufacturing a composite pane for a motor vehicle, comprising:
providing a first pane and a second pane;
providing a plastic film;
introducing at least one depression into the plastic film wherein the at least one depression is introduced such that in a laminated state, the at least one depression is recessed in the direction of the first pane;
arranging a light-emitting diode in the at least one depression of the plastic film, wherein in the laminated state, a light-emission side of the light-emitting diode is oriented in the direction of the first pane;
laminating the first pane and the second pane with interposed plastic film.

9. The method according to claim 8, wherein the at least one depression of the plastic film is introduced into the plastic film by milling using a milling tool and has a diameter of at least 2 mm.

10. The method according to claim 8, wherein the at least one depression of the plastic film is introduced into the plastic film by hot stamping using a hot stamping punch and has a diameter of at least 2 mm.

11. The method according to claim 10, wherein the hot stamping of the at least one depression is carried out with a stamping temperature of the hot stamping punch of 50 to 150° C.

12. The method according to claim 8, wherein the at least one depression is produced with a depth of as much as 90% of a thickness of the plastic film.

13. A method comprising utilizing a composite pane according to claim 1 as a windshield of a motor vehicle.

14. The composite pane according to claim 5, wherein the light-emitting diode has a thickness of as much as 0.7 mm.

15. The composite pane according to claim 6, wherein the at least one depression of the plastic film has a diameter of at least 3 mm.

16. The method according to claim 9, wherein the at least one depression of the plastic film is introduced into the plastic film by milling using a milling tool and has a diameter of at least 3 mm.

17. The method according to claim 10, wherein the at least one depression of the plastic film is introduced into the plastic film by hot stamping using a hot stamping punch and has a diameter of at least 3 mm.

18. The method according to claim 11, wherein the hot stamping of the at least one depression is carried out with a stamping temperature of the hot stamping punch of 80 to 150° C.
